(19) United States
(12) Patent Application Publication
(10) Pub. No.: US 2024/0144049 A1
(43) Pub. Date: May 2, 2024

(54) COMPUTERIZED QUESTION ANSWERING BASED ON EVIDENCE CHAINS

(71) Applicant: Microsoft Technology Licensing, LLC, Redmond, WA (US)

(72) Inventors: Hao CHENG, Kirkland, WA (US); Xiaodong LIU, Redmond, WA (US); Jianfeng GAO, Woodinville, WA (US); Kaixin MA, Pittsburgh, PA (US)

(73) Assignee: Microsoft Technology Licensing, LLC, Redmond, WA (US)

(21) Appl. No.: 17/938,204

(22) Filed: Oct. 5, 2022

(51) Int. Cl. G06N 5/04

(52) U.S. Cl. CPC G06N 5/04

(57) ABSTRACT

A method for computer question answering includes, at a retriever subsystem of a question answering computer system, identifying a plurality of relevant text evidence strings for an input text question. At a linker subsystem of the question answering computer system, one or more of the plurality of relevant text evidence strings are associated with a respective secondary text evidence string to form a plurality of evidence chains via a previously-trained entity-linking machine-learning model. At a chainer subsystem of the question answering computer system, a ranked set of the evidence chains is identified based at least in part on an output of a generative machine-learning model applied to each of the plurality of evidence chains. At a reader subsystem of the question answering computer system, an answer to the input text question is output based at least in part on the ranked set of evidence chains.

### BACKGROUND

Computerized question answering systems are used to generate an answer to an input question by digitally parsing and computationally interpreting external sources of digital information. For instance, in response to the input question “Who is the current president of the United States?” a computerized question answering system evaluates digital evidence sources (e.g., passages of text, documents in a database, webpages of a website) to attempt to extract digital information relevant to the input question and generate an appropriate answer.

Some relatively simple input questions can be answered using only a single evidence source—e.g., a suitable answer to the question is found in a single text passage. However, significant complexity arises when attempting to fuse information from multiple different evidence sources in order to generate an output answer appropriate for answering a question in which all relevant information is not found in a single evidence source. This is particularly true when the evidence is scattered across heterogeneous sources, such as unstructured text and structured tables.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

The present disclosure generally describes methods and systems for computerized question answering. A question answering system receives an input text question, and searches a text evidence corpus (such as a database, online encyclopedia, or other suitable reference) to identify a plurality of text evidence strings that are potentially relevant to the input text question. Relevant text evidence strings are then associated with secondary text evidence strings to form evidence chains—e.g., a table retrieved from one webpage is linked to a corresponding text passage retrieved from another webpage. The evidence chains are evaluated for their relevance to the input text question to give a ranked set of evidence chains, and an answer to the question is output based at least in part on one of the ranked evidence chains.

### BRIEF DESCRIPTION OF THE DRAWINGS

FIG. 1 schematically illustrates an example question answering system providing an answer to an input text question.

FIG. 2 schematically illustrates subsystems of an example question answering system.

FIG. 3 illustrates an example method for computer question answering.

FIG. 4 schematically illustrates identification of relevant text evidence strings for an input text question.

FIG. 5 schematically illustrates associating relevant text evidence strings with corresponding secondary text evidence strings.

FIGS. 6A and 6B schematically illustrate associating a table with a corresponding entity-specific text passage.

FIGS. 7A and 7B schematically illustrate identifying a ranked set of evidence chains.

FIGS. 8A and 8B schematically illustrate outputting an answer to an input text question.

FIG. 9 schematically shows an example computing system.

### DETAILED DESCRIPTION

While some questions can be answered via a single evidence source (e.g., a “single-hop” scenario), the task of open-domain question answering (ODQA) sometimes involves “multi-hop” reasoning—e.g., finding relevant evidence from two or more different knowledge sources, piecing related evidence with context together, and then producing answers based on the final supportive set. One approach for open-domain question answering involves training an iterative passage retriever to identify relevant information from external evidence sources. However, despite their usefulness, iterative passage retrievers trained with both multi-hop and single-hop questions perform poorly over both types. For real-word applications with heterogeneous knowledge sources, it is desirable for an ODQA system to handle both cases well.

Accordingly, the present disclosure describes a question answering computer system that beneficially generalizes well on both single-hop and multi-hop question answering. Specifically, the question answering computer system includes a retriever subsystem for identifying relevant text evidence strings for an input text question from an external text evidence corpus (e.g., online encyclopedia resource), and a reader subsystem for outputting an answer to the input question based at least in part on the relevant evidence.

The question answering computer system additionally includes two intermediary subsystems used in tandem with the retriever and reader subsystems: a linker subsystem and a chainer subsystem. The linker subsystem is used to associate relevant text evidence strings identified by the retriever subsystem with respective secondary evidence strings to form evidence chains. For example, one relevant evidence string identified by the retriever subsystem is an entry in a structured table, which the linker subsystem associates with a corresponding text passage that provides more context for information stored in the table, thereby forming an evidence chain. The chainer subsystem is used to identify a ranked set of evidence chains in a query-dependent manner—e.g., the chainer subsystem compares each evidence chain to the input text question, and identifies the top-k evidence chains based on their predicted relevance to the input question. The reader subsystem then outputs an answer to the input question based at least in part on the ranked set of evidence chains. Notably, the ranked set of evidence chains can include multi-hop evidence chains (e.g., relevant evidence strings linked with secondary evidence), and/or single-hop evidence chains (e.g., relevant evidence strings for which no secondary evidence was found).

In some embodiments, the linker subsystem and chainer subsystem work in a forward-backward fashion. In the forward pass, the linker subsystem links the raw evidence with its related context (e.g., links relevant evidence strings with secondary evidence strings). The chainer subsystem then prunes the evidence chains in a backwards pass using corresponding question generation scores from a generative machine-learning model. In this manner, the chainer subsystem forms a shortlist of relevant evidence chains in a backward noisy channel fashion.

Use of the question answering computer system described herein provides the technical benefit of improving human computer interaction, by improving the accuracy and flexibility of the system's ability to generate output answers in response to input questions for both single-hop and multi-hop scenarios. Furthermore, the question answering computer system described beneficially provides new processes for facilitating information retrieval, by providing new techniques for open-domain question answering that improve upon other question answering solutions.

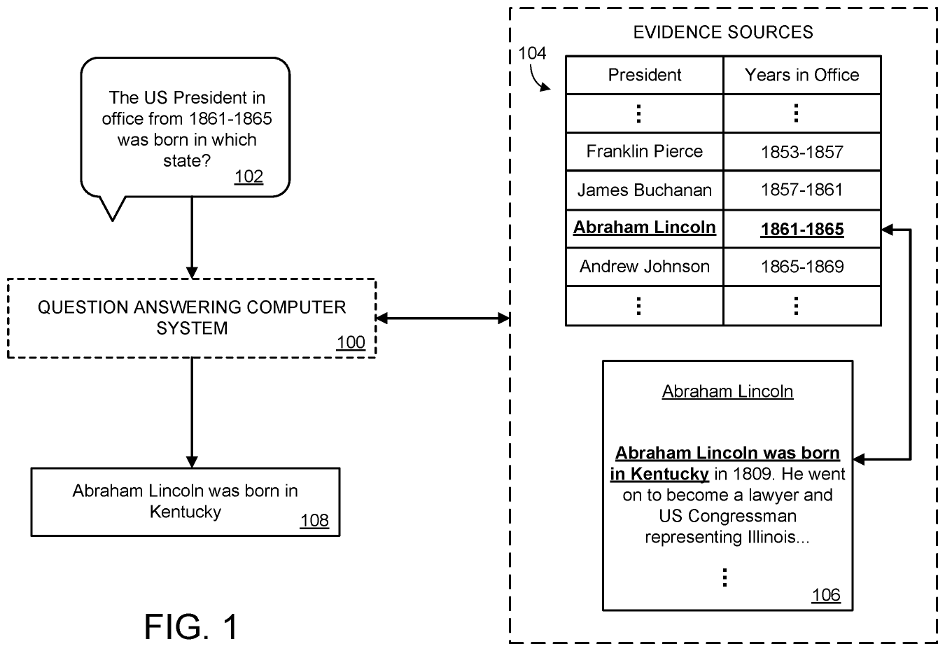

FIG. 1 schematically illustrates an example computerized question answering scenario. It will be understood that FIG. 1 is non-limiting and is highly simplified for the sake of explanation. FIG. 1 schematically shows an example question answering computer system 100. The question answering computer system is generally useable to output an answer to an input question based on one or more evidence sources, as will be described in more detail below.

Use of a question answering computer system beneficially facilitates fast answering of arbitrary input questions, even when the requested information is split between multiple evidence sources that could otherwise require significant time and manual effort to find and parse. This is particularly true in the case of especially long or dense text evidence sources (e.g., the requested information is split between multiple documents each thousands of pages long). In some examples, any or all of the input text question, text evidence corpus, and output answer are transmitted over a suitable computer network (e.g., the Internet), which beneficially enables the output answer to be transmitted to a computing device that is physically remote from one or more other computing devices storing evidence strings from which the answer is derived. Furthermore, the question answering system is useable repeatedly to answer the same or different questions, provided by the same or different users, across a wide range of information domains, again resulting in significant time and effort savings as compared to manual information searching.

In FIG. 1, the question answering computer system receives an input text question 102—specifically, “The US President in office from 1861-1865 was born in which state?” FIG. 1 illustrates a “multi-hop” question answering scenario, in which the information used to answer the question is retrieved from two different evidence sources. Specifically, a table 104 provides a list of US Presidents sorted by their years in office, which is useable to determine that the US President in office from 1861-1865 was Abraham Lincoln. Table 104 is linked to a corresponding text passage 106, which provides more information about Abraham Lincoln, including his birthplace. Thus, the question answering computer system makes a first “hop” from the input text question to table 104, and a second “hop” from table 104 to text passage 106. Based at least in part on the information retrieved from the table 104 and text passage 106, the question answering system outputs an answer 108 to the input text question. Advantageously, answer 108 is provided without requiring human assistance in answering the question, thus allowing full computerized question answering that can be widely deployed in a manner that outperforms human question answering in cost, speed, accuracy, availability, and reproducibility.

It will be understood that, in other examples, the question answering computer system is used in “single-hop” question answering scenarios in addition to or instead of multi-hop scenarios. In other words, the answer to the input text question is identified from a single evidence source (such as table 104), and thus there is only one “hop” from the input question to the evidence that provides an answer to the question. Notably, the question answering computer system described herein provides the technical benefit of improving computerized question answering performance both in multi-hop and single-hop contexts.

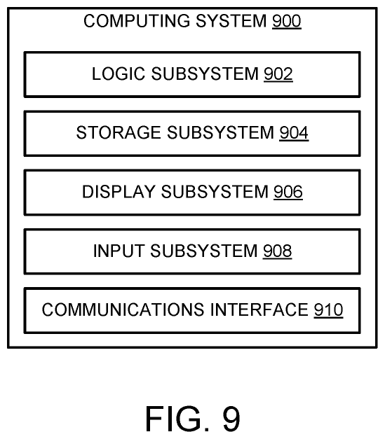

The question answering computer system is implemented via any suitable computer system of one or more computing devices, each having any suitable capabilities, hardware configuration, and form factor. In some embodiments, the question answering computer system is implemented via two or more different computing devices communicating over a network, such as the Internet. As one non-limiting example, the question answering computer system is implemented as computing system 900 described below with respect to FIG. 9.

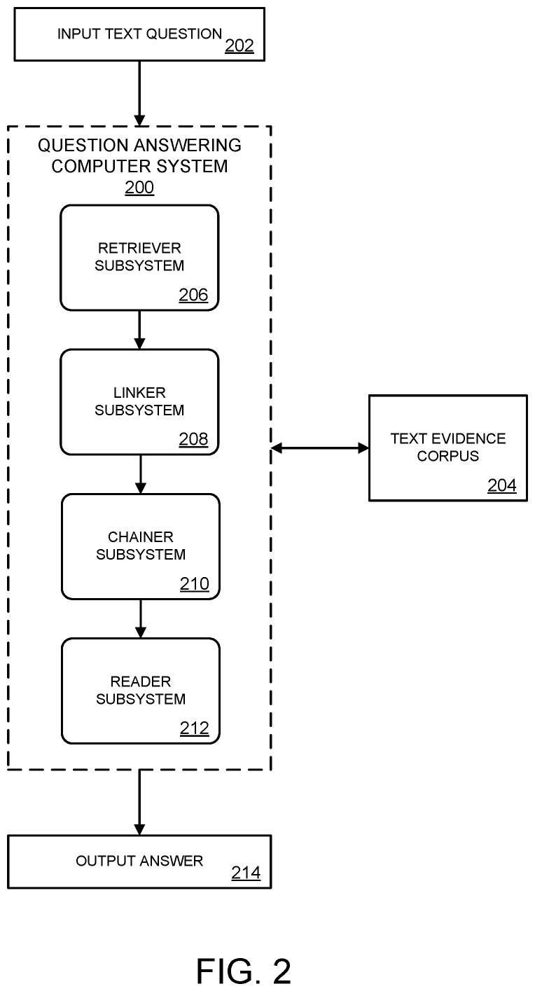

FIG. 2 schematically illustrates operation of an example question answering computer system 200 in more detail. Again, it will be understood that the question answering computer system 200 shown in FIG. 2 is represented schematically and is simplified for the sake of explanation. The question answering computer system is described as including a number of “subsystems” that perform various operations related to generating an answer to an input text question. It will be understood that each of these subsystems are implemented through any suitable combination of computer software, hardware, and/or firmware. An example computing system 900 useable to implement the question answering computer system and each of its various subsystems will be described below with respect to FIG. 9. In some examples, various suitable machine learning (ML) and/or artificial intelligence (AI) techniques are used to implement any or all of the retriever, linker, chainer, and reader subsystems. Non-limiting examples of suitable ML and/or AI techniques are also described below with respect to FIG. 9.

In FIG. 2, the question answering computer system receives an input text question 202, which generically represents any suitable input question provided to a question answering system. Input text question 102 of FIG. 1 is one suitable non-limiting example. It will be understood that the input text question can take any suitable form and have any suitable source. In some examples, the input text question is composed by a human user—e.g., typed into a search bar, or spoken aloud into a microphone and speech-to-text processed. In other examples, the input text question has another suitable source—e.g., loaded from computer storage, or received over a computer network. It will be understood that the present disclosure is primarily concerned with operation of the question answering computer system that the input text question is provided to, regardless of the specific contents or source of the input text question.

The question answering computer system accesses a text evidence corpus 204 to identify text evidence strings that are relevant to the input text question, as will be described in more detail below. The text evidence corpus takes any suitable form. In general, the text evidence corpus includes a plurality of text evidence strings, each of which may or may not be relevant to the input text question. In some examples, the plurality of text evidence strings are retrieved from a plurality of different text evidence sources of the text evidence corpus. As one example, the text evidence corpus includes an online encyclopedia resource, with different webpages of the online encyclopedia serving as different potential evidence sources. Each webpage can include any suitable number of potential text evidence strings, organized and formatted in any suitable way. As one example, the text evidence corpus includes a plurality of webpages that collectively include a plurality of tables (e.g., table 104) and text passages (e.g., text passage 106). The plurality of relevant text evidence strings are then identified from the plurality of tables and the plurality of text passages. In various examples, tables are distinguished from other types of text evidence sources in any suitable way. For instance, tables can be distinguished based on any or all of formatting, metadata, hypertext, etc.

It will be understood that, in other examples, the text evidence corpus takes other suitable forms. For instance, in some examples, the text evidence corpus is implemented as a database including a plurality of database entries, a collection of digital documents or other computer files, and/or any other suitable aggregation of computer data and text strings. In some examples, at least part of the text evidence corpus is stored locally on the question answering computer system, while in other examples, the text evidence corpus is remotely accessed over a computer network (e.g., the Internet).

The text evidence strings of the text evidence corpus similarly take any suitable form. In general, a “text evidence string” refers to any suitable sequence of one or more text characters, including letters, numbers, punctuation, special characters, etc. Thus, as non-limiting examples, text evidence strings include words, sentences, paragraphs, or entire documents. The text evidence corpus in some cases includes one or more tables, as discussed above. Thus, in some cases, text evidence strings include table cells of a table, individual words or other character sequences within a single table cell, two or more table cells together, or the entire table may be treated as a single “text evidence string.” As with the input text question, it will be understood that the text evidence corpus, and the text evidence strings of the text evidence corpus, each take any suitable form and have any suitable source.

In FIG. 2, the question answering computer system includes a retriever subsystem 206, a linker subsystem 208, a chainer subsystem 210, and a reader subsystem 212. More specific details regarding the operations performed by these various subsystems will be given below. In general, the retriever subsystem 206 is used to identify some text evidence strings of the text evidence corpus as being relevant text evidence strings for the input text question. In some embodiments, the question answering computer system is designed to answer questions where the answer is a contiguous span from a table t or a passage p. The table t and/or passage p are retrieved from the text evidence corpus—e.g., including a table corpus [symbol] ₜ of a plurality of tables, and/or a passage corpus [symbol] ₚ, of a plurality of passages. For single-hop questions, a single t or p may be sufficient, whereas for multi-hop questions, one or more t and p are used to find the answer.

Given the initial evidence set (e.g., the relevant text evidence strings identified by the retriever), the intermediary subsystems produce a list of query-dependent evidence chains. First, the linker subsystem 208 is used to expand the candidate evidence set by associating each relevant text evidence string with a respective secondary text evidence string. In some examples, this includes identifying text passages that are related to tables and/or table cells from which the retriever subsystem identified relevant text evidence strings. This beneficially enables the question answering computer system to enrich the evidence context, especially including reasoning chains used for multi-hop questions.

Since there could be many links between one piece of evidence and others (e.g., a densely connected evidence graph), considering all potential links of the query can be computationally expensive for the downstream reader subsystem. Thus, the chainer subsystem 210 is used to identify a ranked set of evidence chains based at least in part on their relevance to the input text question. In some examples, this includes pruning the evidence graph based at least in part on the corresponding input text question to give a ranked set of query-dependent evidence chains. As one example, the chainer subsystem selects the top-k scoring evidence chains for reading by the reader subsystem, which beneficially allows the reader subsystem to work on a fixed computation budget, thereby providing the technical benefit of reducing consumption of computing resources.

The reader subsystem 212 is used to output an answer 214 to the input text question. This is done based at least in part on the ranked set of evidence chains output by the chainer subsystem. In one example, the reader subsystem uses a T5-based generative machine-learning model that encodes each of the top-k evidence chains independently with the input text question. During decoding, the decoder of the generative machine-learning model can attend to all evidence chains, thereby fusing all the input information to give the output answer.

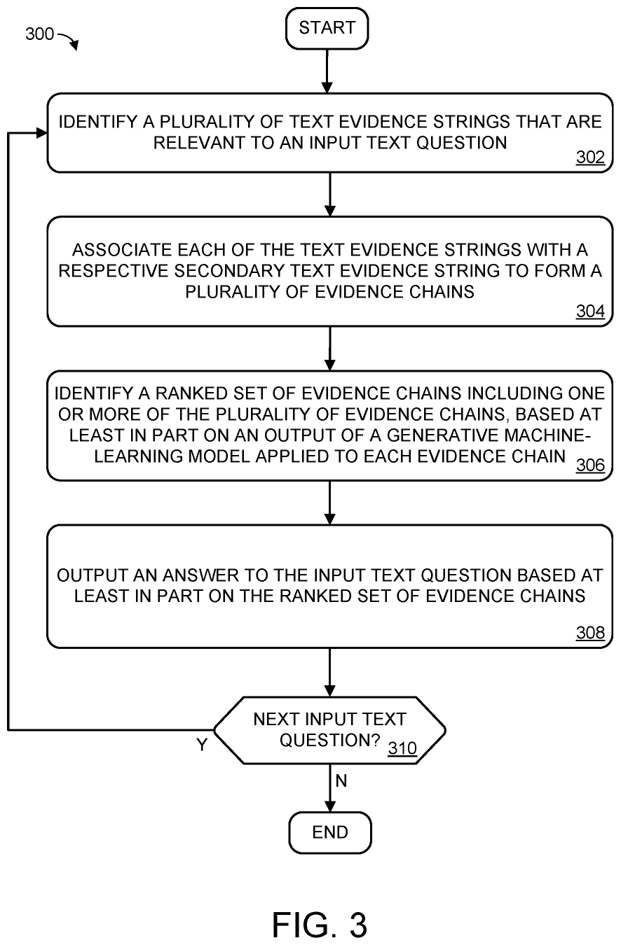

Operation of the question answering computing system will now be described in more detail with respect to FIG. 3, illustrating an example method 300 for computer question answering. Method 300 is implemented by any suitable computing system of one or more computing devices. Any computing device(s) implementing method 300 can have any suitable capabilities, hardware configuration, and form factor. In some embodiments, different steps of method 300 are performed by two or more different computing devices communicating over a computer network. As one non-limiting example, method 300 is implemented by computing system 900 described below with respect to FIG. 9.

At 302, method 300 includes, at the retriever subsystem of the question answering computer system, identifying a plurality of relevant text evidence strings for an input text question, the plurality of relevant text evidence strings identified from a text evidence corpus. This is done in any suitable way. In some non-limiting embodiments, the retriever subsystem includes a pre-trained bi-encoder model including a first text encoder for encoding the input text question as an input question representation, and a second text encoder for encoding corpus text evidence strings of the text evidence corpus as a plurality of text evidence representations. The retriever subsystem then identifies the plurality of relevant text evidence strings from the text evidence corpus by performing a retriever relevance evaluation between the input question representation and the plurality of text evidence representations of the corpus text evidence strings—e.g., comparing vector representations of the input text question and the text evidence strings in vector space.

As one non-limiting example, the retriever subsystem includes a dense passage retriever (DPR) model. The DPR model is a bi-encoder model that includes a question encoder and an evidence encoder. In some examples, the questions and passages/tables are each represented by the [CLS] embedding produced by their respective encoder, and the retrieval is done based at least in part on a maximum inner product search performed in the vector space. Thus, in some examples, DPR is used to retrieve the initial evidence set for a given input text question, where the initial evidence set includes tables and passages.

As discussed above, any suitable number of different text evidence strings are identified from each table and/or text passage. In other words, for a table having a plurality of table cells, one or more of the plurality of relevant text evidence strings are identified from the table (e.g., one table cell of the table, one or more words or character sequences within a cell, two or more cells together, or the entire table). Similarly, one or more relevant text evidence strings can be identified from a single text passage—e.g., one or more words, sentences, or paragraphs together, or the entire text passage, constitute a single relevant text evidence string.

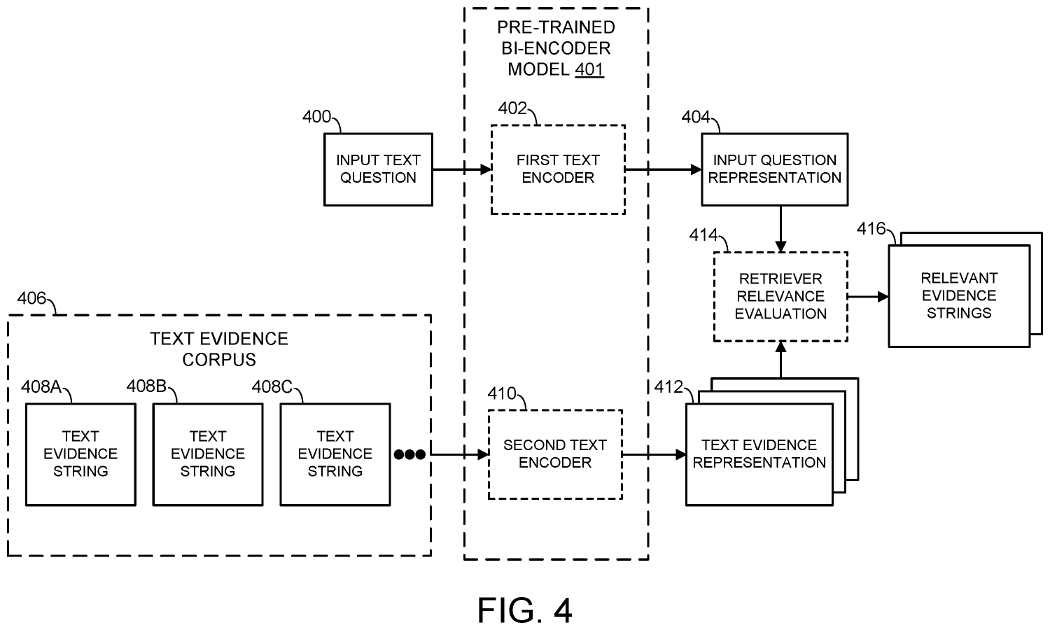

FIG. 4 schematically illustrates example operations performed by a retriever subsystem in some embodiments. As shown, an input question 400 is provided to a pre-trained bi-encoder model 401 (e.g., DPR model) of the retriever subsystem, which uses a first text encoder 402 to output a question representation 404 of the input text question. Similarly, FIG. 4 schematically shows a text evidence corpus 406, including a plurality of corpus text evidence strings 408A-C. Each of these corpus text evidence strings are encoded via a second text encoder 410 of the bi-encoder model to give a corresponding set of text evidence representations.

In some examples, encoding of the corpus text evidence strings is done in a pre-processing step. This beneficially saves time and computational resources of the question answering system when an input text question is provided at runtime, as the input text question is compared to representations of the corpus text evidence strings that have already been encoded. In other examples, however, any or all of the corpus text evidence strings are only encoded once the input text question is provided.

The first and second text encoders are implemented in any suitable way, depending on the specific bi-encoder model used. In some examples, the first and second text encoders are transformer-based text encoders, each using a respective sequence of parameterized transformer blocks to apply encoding operations to input text strings, including the input text question and the input text evidence strings.

In FIG. 4, the retriever subsystem performs a retriever relevance evaluation between the input question representation 404 and the set of text evidence representations 412. The retriever relevance evaluation takes the form of any suitable mathematical operations for evaluating the relative similarity between the input question representation and the plurality of text evidence representations. As one non-limiting example, the retriever relevance evaluation includes performing a maximum inner product search between the input question representation and text evidence representations in vector space.

Regardless, as a result of the retriever relevance evaluation, the retriever subsystem outputs a set of relevant text evidence strings 416, identified as being relevant to the input text question. The set of relevant text evidence strings generally includes at least one, but less than all, corpus text evidence strings of the text evidence corpus, although can include any suitable number of relevant text evidence strings depending on the implementation.

Returning briefly to FIG. 3, at 304, method 300 includes, at the linker subsystem of the question answering computer system, associating one or more of the plurality of relevant text evidence strings with a respective secondary text evidence string to form a plurality of evidence chains. This is done via a previously-trained entity-linking machine-learning model, as will be described in more detail below. As used herein, a “secondary text evidence string” includes a text evidence string of the text evidence corpus that was not initially identified by the retriever subsystem as being relevant to the input text question, though is later associated with one of the relevant text evidence strings by the linker subsystem. For example, the relevant text evidence string is a table cell referencing a particular entity (e.g., Abraham Lincoln), and the secondary text evidence string is a text passage that provides more information regarding the referenced entity, without sharing enough similarity to the input text question to have been identified as a relevant text evidence string by the retriever subsystem.

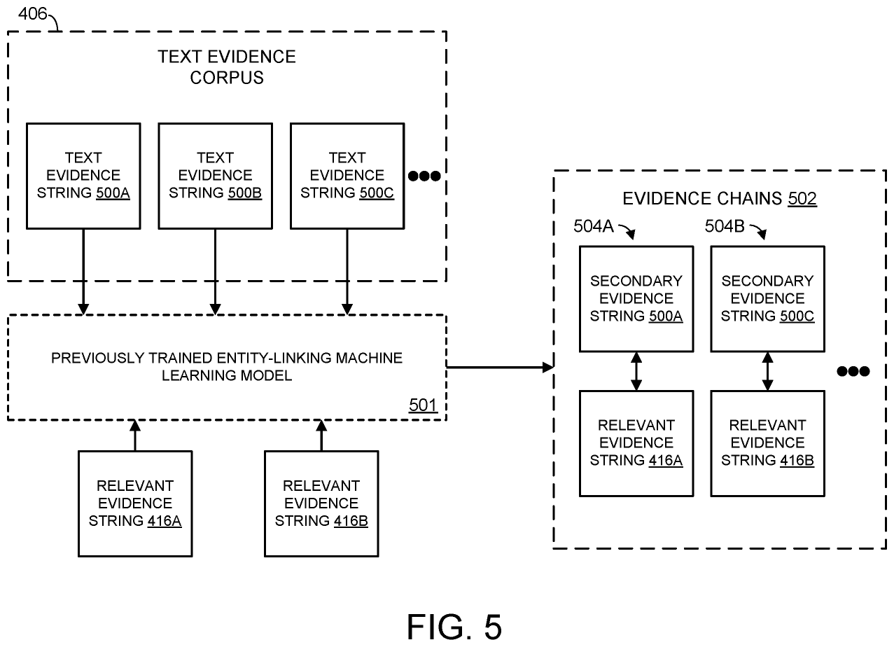

This process is schematically illustrated with respect to FIG. 5, showing two relevant text evidence strings 416A and 416B of the set of relevant text evidence strings identified as described above with respect to FIG. 4. These relevant text evidence strings are compared to corpus text evidence strings of the text corpus, including strings 500A-C of text evidence corpus 406 shown in FIG. 5. The relevant text evidence strings, and corpus text evidence strings of the text evidence corpus, are provided to a previously-trained entity-linking machine learning model 501 of the linker subsystem, which outputs a plurality of evidence chains 502. These include evidence chains 504A and 504B, each comprising a relevant text evidence string associated with a corresponding secondary text evidence string. In this case, corpus text evidence string 500A is identified as a secondary text evidence string associated with relevant string 416A, and corpus text evidence string 500C is identified as a secondary text evidence string associated with relevant string 416B. Corpus text evidence string 500B is not associated with any of the set of relevant text evidence strings.

In some examples, each relevant text evidence string is compared to every corpus text evidence string of the text evidence corpus to identify any secondary strings for the relevant evidence string. In other examples, each relevant evidence string is compared to less than all of the corpus evidence strings, with any suitable filtering criteria used. It will be understood that, in some examples, not all of the relevant text evidence strings are associated with corresponding secondary text evidence strings (e.g., in single-hop scenarios), and that not all of the corpus text evidence strings need be associated with corresponding relevant text evidence strings. In some examples, a single relevant text evidence string is associated with two or more different secondary text evidence strings. Furthermore, in some examples, a secondary text evidence string is itself compared to the corpus text evidence strings to identify a tertiary string for the secondary string (e.g., a “three-hop” scenario). In general, the question answering computer system can associate any number of different text evidence strings with one another to form evidence chains of any suitable length.

Furthermore, in some examples, the linker subsystem is not used for single-hop question answering. In one non-limiting approach, a previously-trained question classifier is used to predict whether a given input text question will require two or more evidence sources. This includes training a linear classifier to classify an encoded question representation as either a single-hop question or a multi-hop question. In this manner, computational resources of the computing system can beneficially be conserved in scenarios where the linker subsystem is not used, as the input text question can be answered using only a single evidence source.

In some examples, the relevant text evidence strings are identified from one or more tables of the text evidence corpus, as discussed above. In such cases, one non-limiting example procedure for the linker subsystem includes encoding the table as a sequence of tokens. The previously-trained entity-linking machine-learning model then identifies candidate entity mentions within the table by predicting, for each token of the sequence of tokens, whether the token refers to an entity. This process is referred to as “entity mention proposal.” Upon identifying a candidate entity mention within the table, the table is associated with an entity-specific text passage corresponding to the entity referred to by one or more tokens of the table (e.g., the candidate entity mention), thereby forming an evidence chain of the plurality of evidence chains. In some examples, the same table is linked to multiple different entity-specific text passages, for different entity mentions within the table.

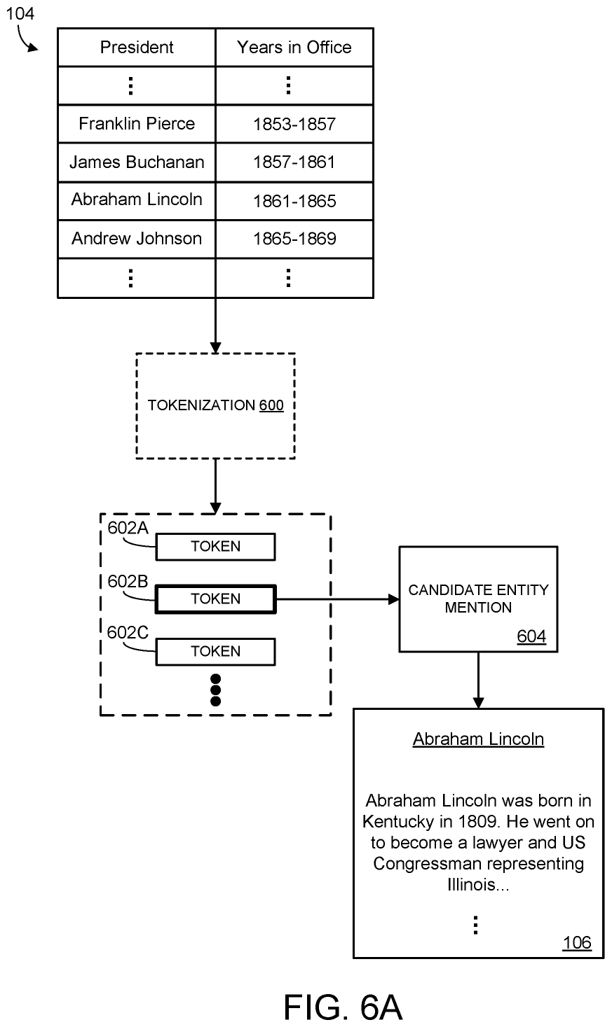

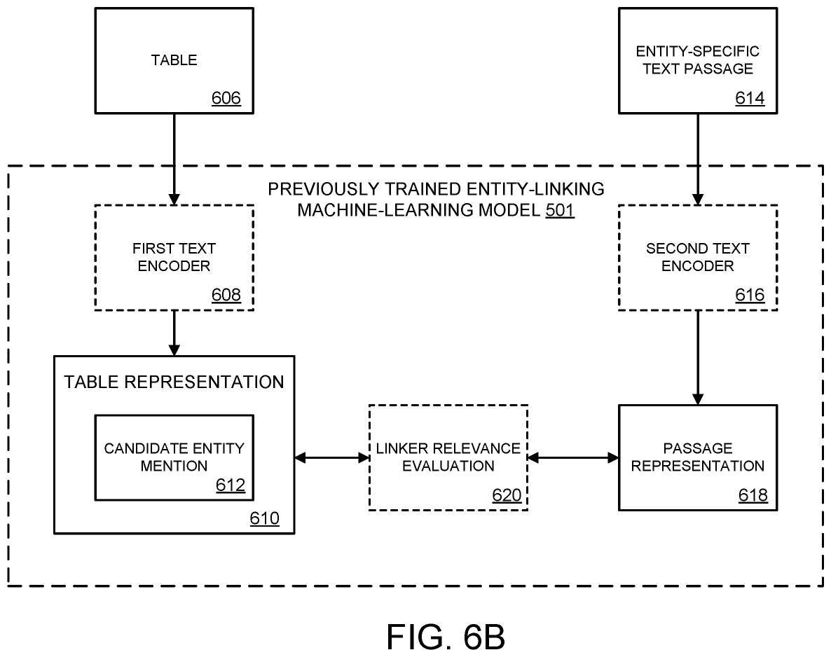

This process is schematically illustrated with respect to FIG. 6A. Specifically, FIG. 6A again shows table 104 of FIG. 1. A tokenization process 600 is applied to the table to generate a sequence of tokens 602A-602C. Any suitable tokenization process is used. In general, each token represents a sequence of one or more text characters in the initial table. For example, different tokens can represent individual words, groups of characters within a single word, individual characters, multiple words, etc. The question answering computer system then evaluates the tokens to predict, for each token, whether the token refers to an entity. In FIG. 6A, 602B is identified as corresponding to a candidate entity mention 604, which is usable to associate table 104 with the corresponding text passage 106, referring to a same entity (e.g., Abraham Lincoln) as the table.

Any suitable number of tokens may be identified as corresponding to candidate entity mentions, although typically less than all tokens of the table will be identified as candidate entity mentions. In some cases, multiple different tokens are identified as referring to the same entity. For instance, the entity “Abraham Lincoln” may be referred to by multiple tokens of the table, and thus multiple tokens comprise the candidate entity mention.

More specific details regarding one suitable approach for entity mention proposal using a previously-trained entity-linking machine learning model will now be described. In general, the entity-linking model first proposes candidate entity mentions (spans) for a given relevant text evidence string, and then links the proposed entity mention to a corresponding entity-specific text passage. In some examples, the candidate entity mentions are identified within one or more tables of the text evidence corpus. As tables often include more high-level summary information than unstructured text passages, using tables as pivots for constructing evidence graphs can beneficially help improve the recall of evidence chains for question answering, thereby providing the technical benefit of improving the performance of the computing system.

In this non-limiting approach, entity mention proposal is performed using a pretrained language model, such as the Bidirectional Encoder Representations from Transformers (BERT) model. For a table of the text evidence corpus, the table is flattened row-wise into a sequence of tokens for deriving table representations from BERT. An input text sequence of length N is denoted as x₁, . . . , x_{N}. Typically, when using BERT, there is a prepended token [CLS] for all input sequences—e.g., [CLS], x₁, . . . , x_{N}. The output is a sequence of hidden states h_{[CLS]}, h₁, . . . , h_{N}∈ [symbol] _{d} from the last BERT layer for each input token, where d is the hidden dimension.

In realistic settings, the ground truth entity mention locations are not provided. Directly applying an off-the-shelf named entity recognition (NER) model can be sub-optimal, as the tables are often structured very differently from the text passages on which the NER models are trained. As such, in this non-limiting approach, the question answering computer system uses a span proposal model to label entity mentions in the table. As one example, BERT is used as the encoder (BERT^{m}), and is used with a linear projection to predict whether each token of the table is part of an entity mention:

h₁^{m}, . . . , h_{N}^{m}=BERT^{m}(t₁, . . . , t_{N})

ŷ=Wh^{m}

Where h^{m}∈ [symbol] ^{Nxd} and W∈ [symbol] ^{2xd}. In some examples, the model is trained with a token-level binary loss:

yₙ log P(ŷ)₁+(1−yₙ)log P(ŷ)₀

Where yₙ is the 0-1 label for the token at position n, and P(⋅) is the softmax function.

In some examples, once candidate entity mentions are identified within a table, the question answering computing system performs a process referred to as “table entity linking” to associate candidate entity mentions within the table to corresponding entity-specific text passages. As one non-limiting approach, the previously-trained entity-linking machine learning model includes a first text encoder for encoding tables as table representations, and a second text encoder for encoding text passages as passage representations. The table is then associated with the entity-specific based at least in part on a linker relevance evaluation performed by comparing a table representation of the table to a passage representation of the entity-specific text passage.

This is schematically illustrated with respect to FIG. 6B, in which a table 606 is provided to a first text encoder 608 of the previously-trained entity-linking machine learning model 501. The first text encoder outputs a table representation 610 of table 608, which includes a candidate entity mention 612 identified as described above. Similarly, an entity-specific text passage 614 is provided to a second text encoder 616 of the previously-trained entity-linking machine learning model 501. The second text encoder outputs a passage representation 618 of the entity-specific text passage. The table representation and passage representation 620 are then compared via a linker relevance evaluation 620 to determine whether the table and passage refer to the same entity, and thereby determine whether the table and passage should be linked as an evidence chain.

More specific details regarding one suitable non-limiting approach for table entity linking using a previously-trained entity-linking machine learning model will now be described. In this approach, once the candidate entity mentions are proposed, a bi-encoder model is used for linking. Specifically, two BERT models are used to encode tables (BERT^{t}) and passages (BERT^{p}), respectively (e.g., first text encoder 608 and second text encoder 616 of FIG. 6B). In cases where there are multiple entity mentions for each table, it is desirable to avoid repetitively inserting additional marker tokens and re-computing representations for each mention occurrence. As such, to represent each entity mention, the question answering computer system uses the entity start and end tokens as well as [CLS]. In other words, for an entity mention with a start position i and end position j in the table, the proposed entity embedding q∈ [symbol] d for linking is computed by:

e=(hᵢ^{t}+hⱼ^{t})/2

q=(e+h_{[CLS]}^{t})/2

For passages, the [CLS] hidden state p=h^{p}_{[CLS]}∈ [symbol] d is directly used as the passage representation.

The previously-trained entity-linking machine learning model is trained in any suitable way. As one non-limiting example, the entity-linking model is trained using a contrastive learning objective:

$${L}_{s i m} = - \frac{exp ( s i m ( q , {p}^{+} ) )}{{\sum }_{{p}^{′} ∈ {p}^{-} ⋃ \{ {p}^{+} \}} exp ( s i m ( q , {p}^{-} ) )}$$

Where p⁺ is the correct linked (positive) passage and p⁻ is the irrelevant set of negative passages. In other words, the previously-trained entity-linking model is trained based at least in part on a plurality of training link examples, including positive examples in which candidate entity mentions are associated with corresponding correct text passages, and negative examples in which candidate entity mentions are associated with corresponding incorrect text passages.

These training examples are generated in any suitable way or collected from any suitable source. As one non-limiting example, the positive examples are collected from an online encyclopedia resource that includes a plurality of tables having ground truth hyperlinks, where each linked mention and the first paragraph of the linked page constitute a positive pair. In one non-limiting example, the BM25 language model is used to mine hard negative pairs for each entity mention. In one example approach for hard negative mining, entity mentions in the table are used as queries, and the system retrieves titles of text passages from an index for each query. In another approach, entity mentions along with the table title are used as queries, and the system retrieves from an index of passage titles concatenated with the first sentence from their corresponding text passages. In some examples, either or both of these strategies are used to identify negative examples for training the entity-linking machine-learning model. In one example training approach, the system randomly samples one hard negative for each entity/positive passage pair, and also uses in-batch negatives to compute the contrastive loss.

In some examples, during inference, the entity span proposal model is used to label entity mentions in the tables. The previously-trained entity-linking machine learning model then links predicted entity mentions to corresponding entity-specific text passages via maximum inner product search. In some cases, it is desirable to search the entire text of an entity-specific text passage, rather than only searching the first paragraph as in the non-limiting training scenario described above.

It will be understood that the above procedures are non-limiting examples of suitable operations that can be performed by the linker subsystem to associated relevant text evidence strings with corresponding secondary text evidence strings. It will be understood that, in other examples, other suitable procedures are used.

Although the linker subsystem can effectively associate text evidence strings relevant to the input question with corresponding secondary evidence, the large amount of resulting information can in some cases be prohibitively large for parsing at the reader subsystem. For instance, one table can include a large number of different entity mentions, each associated with one or more different corresponding text passages, resulting a densely connected evidence graph.

As such, according to the techniques described herein, a chainer subsystem is used to output a ranked set of the evidence chains. As the linker subsystem builds the evidence chains in a query-agnostic manner (e.g., the input text question is not considered when determining whether a particular text evidence string should be linked to another text evidence string as secondary evidence), the chainer subsystem beneficially incorporates the input text question when outputting the ranked set of evidence chains, resulting in a query-dependent set of evidence chains.

As such, returning briefly to FIG. 3, at 306, method 300 includes, at a chainer subsystem of the question answering system, identifying a ranked set of evidence chains including one or more evidence chains of the plurality of evidence chains based at least in part on an output of a generative machine-learning model applied to each of the plurality of evidence chains. In some examples, this includes evaluating the relevance of each evidence chain to the input text question to generate the ranked set of evidence chains, which may include fewer evidence chains than were output by the linker subsystem—e.g., one or more evidence chains output by the linker subsystem are excluded from the ranked set. For example, the chainer subsystem identifies the top-k set of evidence chains scored for their relevance to the input text question, where k has any suitable value depending on the implementation.

Furthermore, the ranked set of evidence chain in some cases includes both single-hop and multi-hop evidence chains. In other words, in some examples, the ranked set of evidence chains include a single-hop evidence chain, representing a relevant text evidence string not associated with any corresponding secondary text evidence strings.

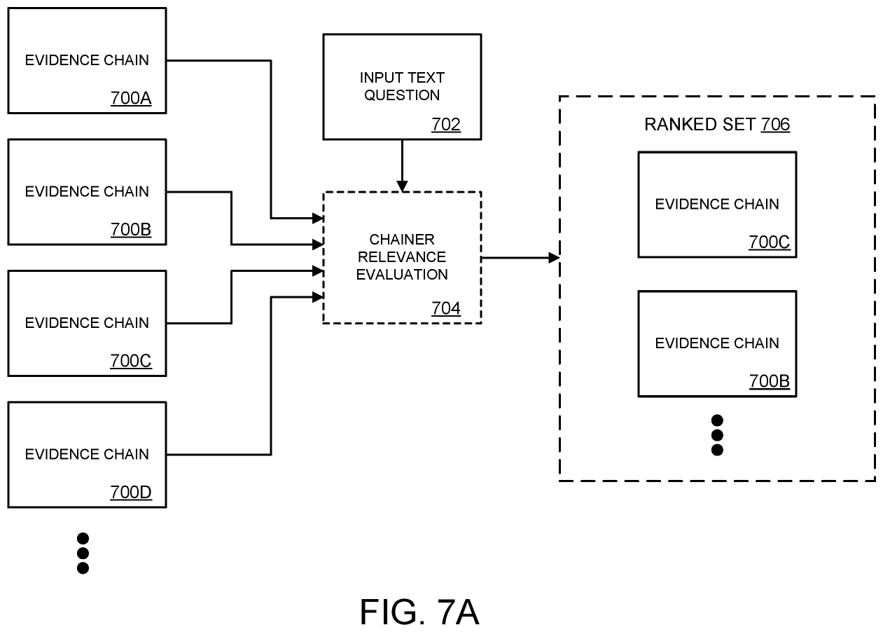

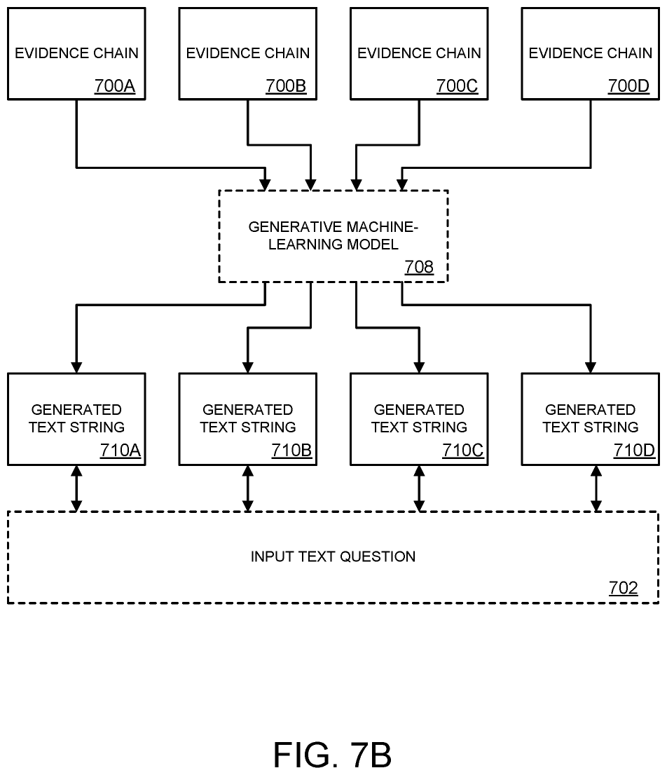

Identification of a ranked set of evidence chains by a chainer subsystem is schematically illustrated with respect to FIG. 7A. Specifically, FIG. 7A, schematically shows several evidence chains 700A-D, output by a linker subsystem as described above. The plurality of evidence chains are compared to an input text question 702 via a chainer relevance evaluation to give a ranked set of evidence chains 706. In this simplified example, the ranked set of evidence chains includes only two evidence chains: evidence chains 700C and 700B. In other examples, the ranked set of evidence chains includes any other suitable number of different evidence chains.

As discussed above, in some examples one table is associated with multiple different text passages. Additionally, or alternatively, one text passage can be linked with multiple different tables. Thus, in some cases, duplication and sequence length can beneficially be reduced by only adding a table to the set of relevant text evidence strings if the table is not already present in the set. Similarly, when identifying secondary text evidence strings, a particular passage is in some cases only included it if it is not already included as secondary evidence. Furthermore, in some cases, a secondary evidence string is concatenated to a table header and a corresponding candidate entity mention in the table, then included as a separate secondary text evidence string from other instances of the same string linked to other candidate entity mentions in the same or different tables.

Non-limiting example operations performed by the chainer subsystem will now be described in more detail. Specifically, in this example, the chainer subsystem includes a generative machine-learning model applied to the evidence chains in evaluating their relevance to the input text question. In some embodiments, the generative machine-learning model is a zero-shot generative language model (e.g., a T0 language model). This beneficially alleviates the need for specialized task-specific training of the model, which reduces consumption of computing resources of the computer system.

According to this non-limiting example approach, a relevance scoring system is used query-dependent hybrid evidence path reranking. Specifically, given a question q, the relevance of a question-table-passage path is modeled using the following conditional:

P(t,p|q)=P(p|t,q)P(t|q)

Where t∈ [symbol] p∈ [symbol] . Given that the linker subsystem is query-agnostic (e.g., only modeling P(p|t)), the formulation lacks a good estimation for P(p|t,q) on the right-hand side. To remedy this, in some examples, the Bayes rule is used:

P(t,p|q)≈P(q|t,p)P(p|t)P(t|q)

In some examples, the question generation likelihood is used to estimate P(q|t,p). Notably, two different conditional variables are present. Naively computing question generation scores on all pairs results in quadratic complexity, which can be undesirably resource intensive for computation by T0. To reduce the inference cost, P(q|t, p) is decomposed into two question generation scores S_{T0}(q|p) and S_{T0}(q|t), both based on the question generation likelihood from T0. In this way, it is possible to reuse S_{T0}(q|t) for corresponding linked passages with a linear cost. To compute S_{T0}(q|p) and S_{T0}(q|t), the instruction “Please write a question based on this passage” is appended to every passage/table, and a mean likelihood of the question tokens conditioned on the passage/table is used to evaluate the relevance of the passage/table to the input text question. In other words, the generative machine-learning model outputs predicted input questions for each evidence chain of the plurality of evidence chains, and the ranked set of evidence chains is identified by comparing the predicted input questions to the input text question.

Because it has been shown that the query-agnostic linker scores are relatively less informative for query-table-passage paths, the retriever score is only combined with two question generation scores as the final chainer score for reranking evidence paths:

$${S}_{R} ( t , q ) + α {S}_{T 0} ( q \vert t ) + β {S}_{T 0} ( q \vert p )$$

$${S}_{R} ( t , q ) = \frac{exp ( s i m ( t , q ) )}{{\sum }_{{t}_{i} ∈ τ} exp ( s i m ( {t}_{i} , q ) )}$$

Where sim(⋅, ⋅) is the unnormalized retriever score, τ is the first-hop evidence set, and α and β are hyperparameters.

For singleton cases (e.g., a first-hop table/passage with no linked secondary evidence), the α and β terms of the above equation are modified to:

2αS_{T0}(q|t)+2βS_{T0}(q|p)

This can beneficially help ensure that the chainer scores for singletons and table/passage paths are on the same scale. Once this is done, both single-hop and multi-hop evidence chains can be sorted to determine the top-k chains for inclusion in the ranked set of evidence chains. In some examples, heuristics are beneficially used to reduce potential duplication.

It will be understood that the above procedures are non-limiting examples of suitable operations that can be performed by the chainer subsystem to associated relevant text evidence strings with corresponding secondary text evidence strings. It will be understood that, in other examples, other suitable procedures are used.

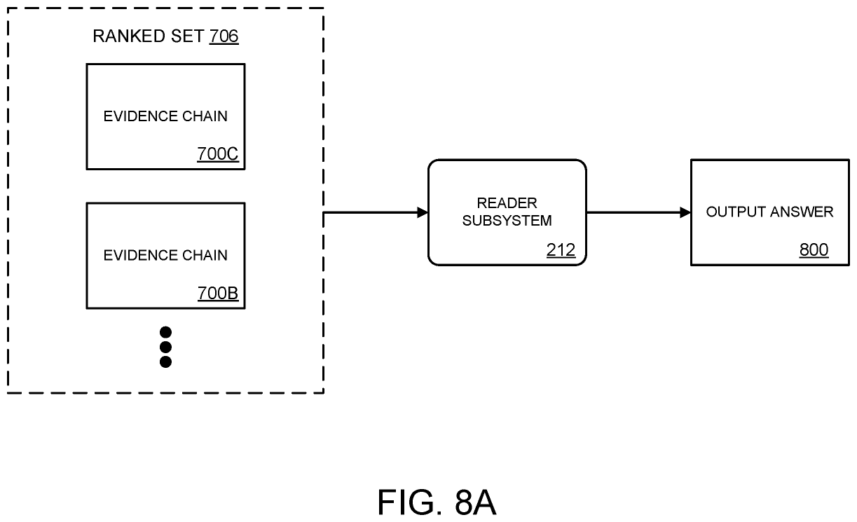

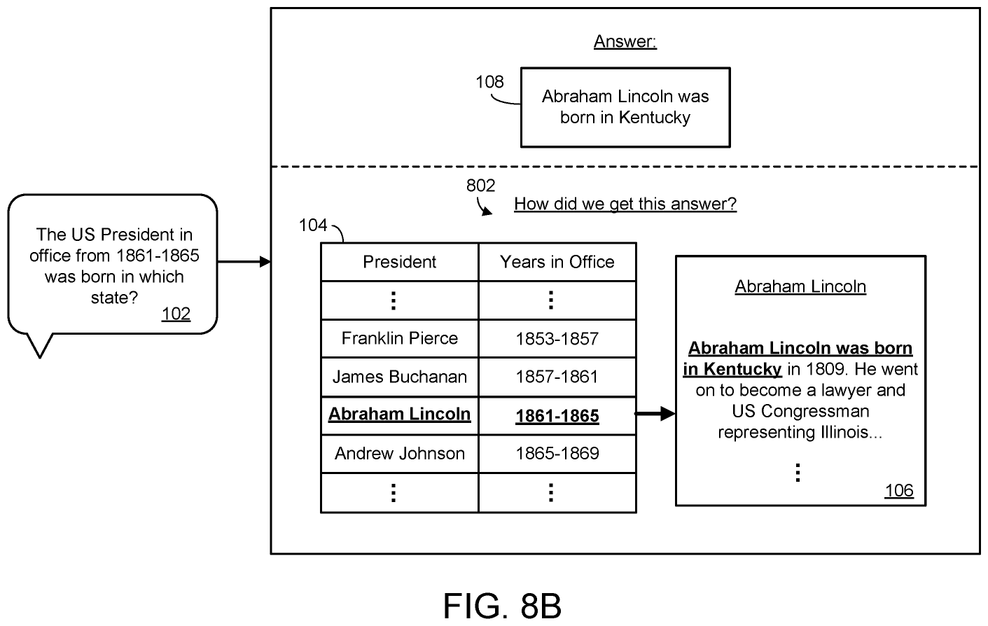

Returning briefly to FIG. 3, at 308, method 300 includes, at a reader subsystem of the question answering system, outputting an answer to the input text question based at least in part on the ranked set of evidence chains. This is schematically illustrated with respect to FIG. 8A. Specifically, FIG. 8A again shows the ranked set 706 of evidence chains output by the chainer subsystem, including evidence chains 700C and 700B. These are provided to the reader subsystem 212 of the question answering computer system, which outputs and answer 800 to the input text question.

This is done in any suitable way. As one non-limiting example, the reader subsystem uses a T5-based generative machine-learning model that encodes each of the top-k evidence chains independently with the input text question. During decoding, the decoder of the generative machine-learning model can attend to all evidence chains, thereby fusing all the input information to give the output answer. In other words, in some examples, the answer to the input text question output by the reader subsystem is derived from two or more evidence chains of the ranked set of evidence chains.

In some examples, outputting an answer to the input text question further includes outputting an answer explanation that specifies a relevant text evidence string and its associated secondary text evidence string of an evidence chain of the ranked set of evidence chains from which the answer is derived. This beneficially improves human-computer interaction by providing the human user with more context as to how and why a particular answer was given to their input question.

Outputting an answer explanation is schematically illustrated with respect to FIG. 8B. Specifically, FIG. 8B again shows input text question 102 of FIG. 1. The question answering computer system outputs answer 108 to the input text question as described above. Furthermore, the question answering computer system provides an answer explanation 802, which specifies the text evidence strings used to generate the output answer—specifically, table 104 and text passage 106. This helps the user to understand the process taken by the computer system in generating the answer—e.g., first by consulting table 104, and then associating table 104 with passage 106.

Returning briefly to FIG. 3, at 310, method 300 includes determining whether another text question has been input for answering. If yes, method 300 proceeds back to step 302 and identifies a plurality of text evidence strings from the text evidence corpus that are relevant to the input text question. If no, method 300 ends until another input text question is provided.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 9 schematically shows a simplified representation of a computing system 900 configured to provide any to all of the compute functionality described herein. Computing system 900 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 900 includes a logic subsystem 902 and a storage subsystem 904. Computing system 900 may optionally include a display subsystem 906, input subsystem 908, communication subsystem 910, and/or other subsystems not shown in FIG. 9.

Logic subsystem 902 includes one or more physical devices configured to execute instructions. For example, the logic subsystem may be configured to execute instructions that are part of one or more applications, services, or other logical constructs. In particular, the logic subsystem may be configured to execute instructions that are used to implement any or all of the retriever subsystem, linker subsystem, chainer subsystem, and reader subsystem described above. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 904 includes one or more physical devices configured to temporarily and/or permanently hold computer information such as data and instructions executable by the logic subsystem. When the storage subsystem includes two or more devices, the devices may be collocated and/or remotely located. Storage subsystem 904 may include volatile, nonvolatile, dynamic, static, read/write, read-only, random-access, sequential-access, location-addressable, file-addressable, and/or content-addressable devices. Storage subsystem 904 may include removable and/or built-in devices. When the logic subsystem executes instructions, the state of storage subsystem 904 may be transformed—e.g., to hold different data.

Aspects of logic subsystem 902 and storage subsystem 904 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

Language models may utilize vocabulary features to guide sampling/searching for words for recognition of speech. For example, a language model may be at least partially defined by a statistical distribution of words or other vocabulary features. For example, a language model may be defined by a statistical distribution of n-grams, defining transition probabilities between candidate words according to vocabulary statistics. The language model may be further based on any other appropriate statistical features, and/or results of processing the statistical features with one or more machine learning and/or statistical algorithms (e.g., confidence values resulting from such processing). In some examples, a statistical model may constrain what words may be recognized for an audio signal, e.g., based on an assumption that words in the audio signal come from a particular vocabulary.

Alternately or additionally, the language model may be based on one or more neural networks previously-trained to represent audio inputs and words in a shared latent space, e.g., a vector space learned by one or more audio and/or word models (e.g., wav2letter and/or word2vec). Accordingly, finding a candidate word may include searching the shared latent space based on a vector encoded by the audio model for an audio input, in order to find a candidate word vector for decoding with the word model. The shared latent space may be utilized to assess, for one or more candidate words, a confidence that the candidate word is featured in the speech audio.

The language model may be used in conjunction with an acoustical model configured to assess, for a candidate word and an audio signal, a confidence that the candidate word is included in speech audio in the audio signal based on acoustical features of the word (e.g., mel-frequency cepstral coefficients, formants, etc.). Optionally, in some examples, the language model may incorporate the acoustical model (e.g., assessment and/or training of the language model may be based on the acoustical model). The acoustical model defines a mapping between acoustic signals and basic sound units such as phonemes, e.g., based on labelled speech audio. The acoustical model may be based on any suitable combination of state-of-the-art or future machine learning (ML) and/or artificial intelligence (AI) models, for example: deep neural networks (e.g., long short-term memory, temporal convolutional neural network, restricted Boltzmann machine, deep belief network), hidden Markov models (HMM), conditional random fields (CRF) and/or Markov random fields, Gaussian mixture models, and/or other graphical models (e.g., deep Bayesian network). Audio signals to be processed with the acoustic model may be pre-processed in any suitable manner, e.g., encoding at any suitable sampling rate, Fourier transform, band-pass filters, etc. The acoustical model may be trained to recognize the mapping between acoustic signals and sound units based on training with labelled audio data. For example, the acoustical model may be trained based on labelled audio data comprising speech audio and corrected text, in order to learn the mapping between the speech audio signals and sound units denoted by the corrected text. Accordingly, the acoustical model may be continually improved to improve its utility for correctly recognizing speech audio.

In some examples, in addition to statistical models, neural networks, and/or acoustical models, the language model may incorporate any suitable graphical model, e.g., a hidden Markov model (HMM) or a conditional random field (CRF). The graphical model may utilize statistical features (e.g., transition probabilities) and/or confidence values to determine a probability of recognizing a word, given the speech audio and/or other words recognized so far. Accordingly, the graphical model may utilize the statistical features, previously trained machine learning models, and/or acoustical models to define transition probabilities between states represented in the graphical model.

When included, display subsystem 906 may be used to present a visual representation of data held by storage subsystem 904. This visual representation may take the form of a graphical user interface (GUI). Display subsystem 906 may include one or more display devices utilizing virtually any type of technology. In some implementations, display subsystem may include one or more virtual-, augmented-, or mixed reality displays.

When included, input subsystem 908 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 910 may be configured to communicatively couple computing system 900 with one or more other computing devices. Communication subsystem 910 may include wired and/or wireless communication devices compatible with one or more different communication protocols. The communication subsystem may be configured for communication via personal-, local- and/or wide-area networks.

The methods and processes disclosed herein may be configured to give users and/or any other humans control over any private and/or potentially sensitive data. Whenever data is stored, accessed, and/or processed, the data may be handled in accordance with privacy and/or security standards. When user data is collected, users or other stakeholders may designate how the data is to be used and/or stored. Whenever user data is collected for any purpose, the user data may only be collected with the utmost respect for user privacy (e.g., user data may be collected only when the user owning the data provides affirmative consent, and/or the user owning the data may be notified whenever the user data is collected). If the data is to be released for access by anyone other than the user or used for any decision-making process, the user's consent may be collected before using and/or releasing the data. Users may opt-in and/or opt-out of data collection at any time. After data has been collected, users may issue a command to delete the data, and/or restrict access to the data. All potentially sensitive data optionally may be encrypted and/or, when feasible, anonymized, to further protect user privacy. Users may designate portions of data, metadata, or statistics/results of processing data for release to other parties, e.g., for further processing. Data that is private and/or confidential may be kept completely private, e.g., only decrypted temporarily for processing, or only decrypted for processing on a user device and otherwise stored in encrypted form. Users may hold and control encryption keys for the encrypted data. Alternately or additionally, users may designate a trusted third party to hold and control encryption keys for the encrypted data, e.g., so as to provide access to the data to the user according to a suitable authentication protocol.

When the methods and processes described herein incorporate ML and/or AI components, the ML and/or AI components may make decisions based at least partially on training of the components with regard to training data. Accordingly, the ML and/or AI components may be trained on diverse, representative datasets that include sufficient relevant data for diverse users and/or populations of users. In particular, training data sets may be inclusive with regard to different human individuals and groups, so that as ML and/or AI components are trained, their performance is improved with regard to the user experience of the users and/or populations of users.

ML and/or AI components may additionally be trained to make decisions so as to minimize potential bias towards human individuals and/or groups. For example, when AI systems are used to assess any qualitative and/or quantitative information about human individuals or groups, they may be trained so as to be invariant to differences between the individuals or groups that are not intended to be measured by the qualitative and/or quantitative assessment, e.g., so that any decisions are not influenced in an unintended fashion by differences among individuals and groups.

ML and/or AI components may be designed to provide context as to how they operate, so that implementers of ML and/or AI systems can be accountable for decisions/assessments made by the systems. For example, ML and/or AI systems may be configured for replicable behavior, e.g., when they make pseudo-random decisions, random seeds may be used and recorded to enable replicating the decisions later. As another example, data used for training and/or testing ML and/or AI systems may be curated and maintained to facilitate future investigation of the behavior of the ML and/or AI systems with regard to the data. Furthermore, ML and/or AI systems may be continually monitored to identify potential bias, errors, and/or unintended outcomes.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for computer question answering comprises: at a retriever subsystem of a question answering computer system, identifying a plurality of relevant text evidence strings for an input text question, the plurality of relevant text evidence strings identified from a text evidence corpus; at a linker subsystem of the question answering computer system, associating one or more of the plurality of relevant text evidence strings with a respective secondary text evidence string to form a plurality of evidence chains via a previously trained entity-linking machine-learning model; at a chainer subsystem of the question answering computer system, identifying a ranked set of evidence chains including one or more evidence chains of the plurality of evidence chains based at least in part on an output of a generative machine-learning model applied to each of the plurality of evidence chains; and at a reader subsystem of the question answering computer system, outputting an answer to the input text question based at least in part on the ranked set of evidence chains. In this example or any other example, the generative machine-learning model outputs predicted input questions for each evidence chain of the plurality of evidence chains, and the ranked set of evidence chains is identified by comparing the predicted input questions to the input text question. In this example or any other example, the generative machine-learning model is a zero-shot generative language model. In this example or any other example, identifying the ranked set of evidence chains includes excluding, from the ranked set of evidence chains, one or more evidence chains output by the linker subsystem. In this example or any other example, the ranked set of evidence chains include a single-hop evidence chain, representing a relevant text evidence string not associated with any corresponding secondary text evidence strings. In this example or any other example, the retriever subsystem includes a pre-trained bi-encoder including a first text encoder for encoding the input text question as an input question representation, and a second text encoder for encoding corpus text evidence strings of the text evidence corpus as a plurality of text evidence representations. In this example or any other example, the retriever subsystem identifies the plurality of relevant text evidence strings from the text evidence corpus by performing a retriever relevance evaluation between the input question representation and the plurality of text evidence representations of the corpus text evidence strings. In this example or any other example, the text evidence corpus includes a table having a plurality of table cells, and wherein one or more of the plurality of relevant text evidence strings are identified from the table. In this example or any other example, the method further comprises encoding the table as a sequence of tokens, and wherein the previously-trained entity-linking machine-learning model identifies candidate entity mentions within the table by predicting, for each token of the sequence of tokens, whether the token refers to an entity. In this example or any other example, the table is associated with an entity-specific text passage corresponding to the entity referred to by one or more tokens of the table, thereby forming an evidence chain of the plurality of evidence chains. In this example or any other example, the previously-trained entity-linking machine-learning model includes a first text encoder for encoding tables as table representations, and a second text encoder for encoding text passages as passage representations, and the table is associated with the entity-specific text passage based at least in part on a linker relevance evaluation performed by comparing a table representation of the table to a passage representation of the entity-specific text passage. In this example or any other example, the previously-trained entity-linking machine-learning model is trained based at least in part on a plurality of training link examples using a contrastive learning objective, including positive examples in which candidate entity mentions are associated with corresponding correct text passages, and negative examples in which candidate entity mentions are associated with corresponding incorrect text passages. In this example or any other example, the text evidence corpus includes a plurality of webpages, the plurality of webpages collectively including a plurality of tables and a plurality of text passages, and wherein the plurality of relevant text evidence strings are identified from the plurality of tables and the plurality of text passages. In this example or any other example, the answer to the input text question output by the reader subsystem is derived from two or more evidence chains of the ranked set of evidence chains. In this example or any other example, the method further comprises outputting an answer explanation of the answer to the input text question, the answer explanation specifying a relevant text evidence string and its associated secondary text evidence string of an evidence chain of the ranked set of evidence chains from which the answer is derived.

In an example, a computing system comprises: a logic subsystem; and a storage subsystem holding instructions executable by the logic subsystem to implement a question computer answering system, the question answering computer system comprising: a retriever subsystem to identify a plurality of relevant text evidence strings for an input text question, the plurality of relevant text evidence strings identified from one or more tables of a text evidence corpus including a plurality of tables and a plurality of text passages; a linker subsystem to associate one or more of the plurality of relevant text evidence strings with a respective secondary text evidence string to form a plurality of evidence chains via a previously-trained entity-linking machine-learning model, each secondary text evidence string identified from one or more text passages of the plurality of text passages; a chainer subsystem to identify a ranked set of evidence chains including one or more evidence chains of the plurality of evidence chains based at least in part on an output of a generative machine-learning model applied to each of the plurality of evidence chains; and a reader subsystem to output an answer to the input text question based at least in part on the ranked set of evidence chains. In this example or any other example, the linker subsystem encodes a table of the plurality of tables as a sequence of tokens, and the previously-trained entity-linking machine-learning model identifies candidate entity mentions within the table by predicting, for each token of the sequence of tokens, whether the token refers to an entity. In this example or any other example, identifying the ranked set of evidence chains includes excluding, from the ranked set of evidence chains, one or more evidence chains output by the linker subsystem. In this example or any other example, the ranked set of evidence chains include a single-hop evidence chain, representing a relevant text evidence string not associated with any corresponding secondary text evidence strings.

In an example, a method for computer question answering comprises: at a linker subsystem of a question answering computer system, receiving a plurality of relevant text evidence strings identified from a text evidence corpus as being relevant to an input text question, and associating one or more of the plurality of relevant text evidence strings with a respective secondary text evidence string to form a plurality of evidence chains via a previously-trained entity-linking machine-learning model; at a chainer subsystem of the question answering computer system, identifying a ranked set of evidence chains including one or more evidence chains of the plurality of evidence chains, the ranked set of evidence chains identified by using a generative machine-learning model to generate a predicted input question for each evidence chain of the plurality of evidence chains, and comparing each predicted input question to the input text question; and outputting an answer to the input text question based at least in part on the ranked set of evidence chains.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for computer question answering, the method comprising:
at a retriever subsystem of a question answering computer system, identifying a plurality of relevant text evidence strings for an input text question, the plurality of relevant text evidence strings identified from a text evidence corpus;
at a linker subsystem of the question answering computer system, associating one or more of the plurality of relevant text evidence strings with a respective secondary text evidence string to form a plurality of evidence chains via a previously trained entity-linking machine-learning model;
at a chainer subsystem of the question answering computer system, identifying a ranked set of evidence chains including one or more evidence chains of the plurality of evidence chains based at least in part on an output of a generative machine-learning model applied to each of the plurality of evidence chains; and
at a reader subsystem of the question answering computer system, outputting an answer to the input text question based at least in part on the ranked set of evidence chains.

2. The method of claim 1, wherein the generative machine-learning model outputs predicted input questions for each evidence chain of the plurality of evidence chains, and the ranked set of evidence chains is identified by comparing the predicted input questions to the input text question.

3. The method of claim 1, wherein the generative machine-learning model is a zero-shot generative language model.

4. The method of claim 1, wherein identifying the ranked set of evidence chains includes excluding, from the ranked set of evidence chains, one or more evidence chains output by the linker subsystem.

5. The method of claim 1, wherein the ranked set of evidence chains include a single-hop evidence chain, representing a relevant text evidence string not associated with any corresponding secondary text evidence strings.

6. The method of claim 1, wherein the retriever subsystem includes a pre-trained bi-encoder including a first text encoder for encoding the input text question as an input question representation, and a second text encoder for encoding corpus text evidence strings of the text evidence corpus as a plurality of text evidence representations.

7. The method of claim 6, wherein the retriever subsystem identifies the plurality of relevant text evidence strings from the text evidence corpus by performing a retriever relevance evaluation between the input question representation and the plurality of text evidence representations of the corpus text evidence strings.

8. The method of claim 1, wherein the text evidence corpus includes a table having a plurality of table cells, and wherein one or more of the plurality of relevant text evidence strings are identified from the table.

9. The method of claim 8, further comprising encoding the table as a sequence of tokens, and wherein the previously-trained entity-linking machine-learning model identifies candidate entity mentions within the table by predicting, for each token of the sequence of tokens, whether the token refers to an entity.

10. The method of claim 9, wherein the table is associated with an entity-specific text passage corresponding to the entity referred to by one or more tokens of the table, thereby forming an evidence chain of the plurality of evidence chains.

11. The method of claim 10, wherein the previously-trained entity-linking machine-learning model includes a first text encoder for encoding tables as table representations, and a second text encoder for encoding text passages as passage representations, and the table is associated with the entity-specific text passage based at least in part on a linker relevance evaluation performed by comparing a table representation of the table to a passage representation of the entity-specific text passage.

12. The method of claim 11, wherein the previously-trained entity-linking machine-learning model is trained based at least in part on a plurality of training link examples using a contrastive learning objective, including positive examples in which candidate entity mentions are associated with corresponding correct text passages, and negative examples in which candidate entity mentions are associated with corresponding incorrect text passages.

13. The method of claim 1, wherein the text evidence corpus includes a plurality of webpages, the plurality of webpages collectively including a plurality of tables and a plurality of text passages, and wherein the plurality of relevant text evidence strings are identified from the plurality of tables and the plurality of text passages.

14. The method of claim 1, wherein the answer to the input text question output by the reader subsystem is derived from two or more evidence chains of the ranked set of evidence chains.

15. The method of claim 1, further comprising outputting an answer explanation of the answer to the input text question, the answer explanation specifying a relevant text evidence string and its associated secondary text evidence string of an evidence chain of the ranked set of evidence chains from which the answer is derived.

16. A computing system, comprising:
a logic subsystem; and
a storage subsystem holding instructions executable by the logic subsystem to implement a question computer answering system, the question answering computer system comprising:
a retriever subsystem to identify a plurality of relevant text evidence strings for an input text question, the plurality of relevant text evidence strings identified from one or more tables of a text evidence corpus including a plurality of tables and a plurality of text passages;
a linker subsystem to associate one or more of the plurality of relevant text evidence strings with a respective secondary text evidence string to form a plurality of evidence chains via a previously-trained entity-linking machine-learning model, each secondary text evidence string identified from one or more text passages of the plurality of text passages;
a chainer subsystem to identify a ranked set of evidence chains including one or more evidence chains of the plurality of evidence chains based at least in part on an output of a generative machine-learning model applied to each of the plurality of evidence chains; and
a reader subsystem to output an answer to the input text question based at least in part on the ranked set of evidence chains.

17. The computing system of claim 16, wherein the linker subsystem encodes a table of the plurality of tables as a sequence of tokens, and wherein the previously-trained entity-linking machine-learning model identifies candidate entity mentions within the table by predicting, for each token of the sequence of tokens, whether the token refers to an entity.

18. The computing system of claim 16, wherein identifying the ranked set of evidence chains includes excluding, from the ranked set of evidence chains, one or more evidence chains output by the linker subsystem.

19. The computing system of claim 16, wherein the ranked set of evidence chains include a single-hop evidence chain, representing a relevant text evidence string not associated with any corresponding secondary text evidence strings.

20. A method for computer question answering, the method comprising:
at a linker subsystem of a question answering computer system, receiving a plurality of relevant text evidence strings identified from a text evidence corpus as being relevant to an input text question, and associating one or more of the plurality of relevant text evidence strings with a respective secondary text evidence string to form a plurality of evidence chains via a previously-trained entity-linking machine-learning model;
at a chainer subsystem of the question answering computer system, identifying a ranked set of evidence chains including one or more evidence chains of the plurality of evidence chains, the ranked set of evidence chains identified by using a generative machine-learning model to generate a predicted input question for each evidence chain of the plurality of evidence chains, and comparing each predicted input question to the input text question; and
outputting an answer to the input text question based at least in part on the ranked set of evidence chains.
